(19) United States
(12) Patent Application Publication
(10) Pub. No.: US 2003/0004984 A1
(43) Pub. Date: Jan. 2, 2003

(54) Methods for transcoding webpage and creating personal profile

(75) Inventor: David Chou, Taipei (TW)

Correspondence Address: Ladas & Parry, 26 West 61st Street, New York, NY, 10023, US

(73) Assignee: ISCREEN CORPORATION

(21) Appl. No.: 10/038,692

(22) Filed: Jan. 2, 2002

(30) Foreign Application Priority Data
Jul. 2, 2001 (TW) 90116127

(51) Int. Cl. G06F 15/00

(52) U.S. Cl. 707/500

(57) ABSTRACT

The invention relates to methods for transcoding a webpage and creating a personal profile. The method for transcoding a webpage comprises the steps of: (i) retrieving a specific webpage; (ii) analyzing the specific webpage; (iii) dividing the specific webpage into at least two groups; (iv) transcoding the at least two groups from a first language into a second language according to a predetermined parameter; and (v) outputting the transcoded groups to a mobile device. The method for creating a personal profile comprises the steps of: inputting a Chinese or English URL address through a computer or a mobile device; (ii) retrieving a corresponding webpage through a reformatter and disabling the double clicking function; (iii) selecting contents in the webpage to be displayed; and (iv) assigning a name to the selected contents and storing the selected contents and the name. According to the methods of the present invention, a user can easily access the Internet based on his own requirements through a mobile device.

### BACKGROUND OF THE INVENTION

1. Field of the Invention

The present invention relates to a transcoding method, and in particular to a method for transcoding webpages.

2. Description of the Related Art

The most common language for writing a webpage is HyperText Markup Language (HTML), but on a mobile phone, HTML cannot be shown. The major languages that can be shown on a mobile phone is Wireless Markup Language (WML), but WML is supported by Wireless Application Protocol (WAP) browsers only. Although there are billions of websites written by HTML now, none of them is suitable to view on a mobile phone in today's environment. And it is not cost effective for the existing websites to spend time and money on writing a website in WML. Besides, limited graphic images can be shown on a mobile phone now.

If users want to access webpages on their mobile devices, they can only access those WAP-supporting websites. This limits the usage of mobile devices and the visitors to the websites. A reason for the limitation is that most WAP users can only view the contents prescribed by their operators or content providers.

Many WAP customers are restricted, one way or another, to view only the contents provided by their operator's WAP portal. For some WAP users, their handsets restrict movements from a portal to another portal. In addition, some mobile phones do not allow users to enter a Uniform Resource Locator (URL). Instead, users can only links to WAP portal provided by the operators.

Even if the operators do not restrict the users from going to all WAP sites, it is troublesome to input the whole URL on a mobile phone. It is commonly agreed by the users that the inputting method of a mobile phone is not convenient now. Therefore, some kinds of intelligent input methods will help the users to save a lot of time by shortening the input URL. Another obstacle is that most of the mobile phones only provide a limited number of bookmark function. Therefore, if users want to revisit webpages, contents or their favorite WAP-enabled sites later, they have to remember the URL and type in the whole URL again.

There are some pocket devices which have the Internet browser embedded inside. However, the function of this kind of Internet browser is the same as the one on a personal computer. Such browser will retrieve all the contents of the website to the pocket devices. The most common elements of a webpage comprise HyperLinks, text and graphics. However, due to the limited size of a screen, the contents of the website will be separated into many pages if the contents are large. The users have no choice but browse through the website according to the design of the website. It will at least triple the browsing time and it is not user friendly. In addition, the users need to pay for more connection fee incurred. Furthermore, flash and animated graphics are widely used on many websites nowadays. Besides, these kinds of graphics and webpages will not be supported by the browser.

In addition, there are different models of mobile devices with different functions, such as different sizes of screen, resolutions and speeds, etc. Writing a WAP enabled site will be time consuming for a webmaster as the speed of launching a new mobile device is fast.

iMode is a wireless technology developed by a Japanese company, NTT DoCoMo, that enables users to access Internet services via their cellular phones. iMode (the “i” stands for information) is based on packet data transmission technology. Only users having iMode devices can view the iMode sites written by compact HTML (cHTML). However, users in Taiwan cannot view iMode compatible websites as the services are only launched in Japan now.

Accordingly, there is a need for automatically transcoding the webpage contents written by HTML into WML, cHTML or PDX such that mobile devices can easily access the Internet.

### SUMMARY OF THE INVENTION

It is an object of the present invention to automatically transcode the webpage contents written by HTML into WML, cHTML, PDX or other formats such that mobile devices can easily access the Internet.

It is another object of the present invention to re-arrange the accessed webpage contents and display them on the mobile devices.

It is a further object of the present invention to personalize the accessed webpage contents and simplify a Chinese/English input procedure.

It is a further object of the present invention to provide a computer readable recording medium embedded with computer program for automatically transcoding the webpage contents written by HTML into WML, cHTML, PDX or other formats such that mobile devices can easily access the Internet.

### BRIEF DESCRIPTION OF THE DRAWINGS

For a more complete understanding of the present invention and the advantages thereof, reference is now made to the following descriptions taken in conjunction with the accompanying drawings which illustrate the embodiments of the present invention, wherein:

FIG. 1 is a schematic diagram of a system of the present invention;

FIG. 2 is a flow chart of a method for transcoding webpage of the present invention; and

FIG. 3 is a flow chart of a method for creating personal profile to accessed webpage contents of the present invention.

### DETAILED DESCRIPTION OF THE PREFERRED EMBODIMENTS

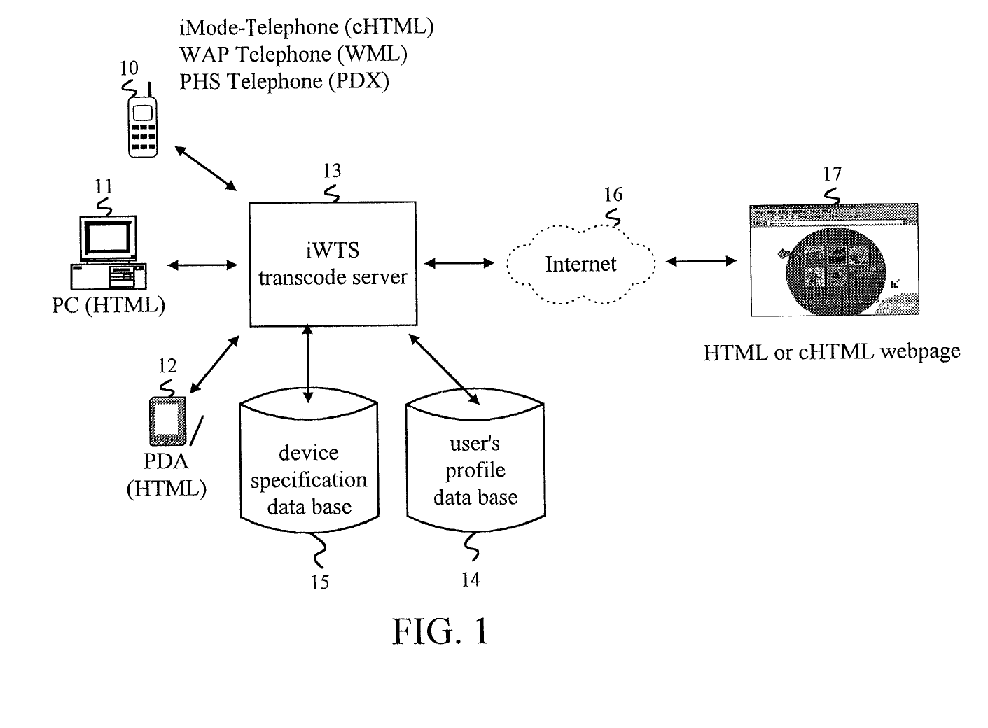

Referring to FIG. 1, FIG. 1 is a schematic diagram of a system of the present invention, wherein a transcode server 13 is the system core of the present invention. The main function of the transcode server 13 is to transcode a first webpage language (such as HTML or cHTML) for a webpage 17, iMode contents or PDA 12 to a second language (such as cHTML, WML, PDX or other formats) for a mobile phone 10. Another function of the transcode server 13 is to create personal wireless webpages and store the created personal webpages in a user's profile database 14 for future use. In addition, the transcode server 13 further comprises a device specification database 15 for storing the specifications (such as the size of the screen, the number of pixel, the number of characters which can be displayed in a row, the color of the screen or font of the character (traditional Chinese character, simplified Chinese character, Japanese character or Korean character and so on)) of the mobile phone 10 or PDA 12. The specification can be selected and outputted automatically according to the used mobile phone or PDA to achieve the best visual effect. According to the system of the present invention, the mobile phone 10 or PDA 12 can easily access the desired webpage 17 via the Internet 16.

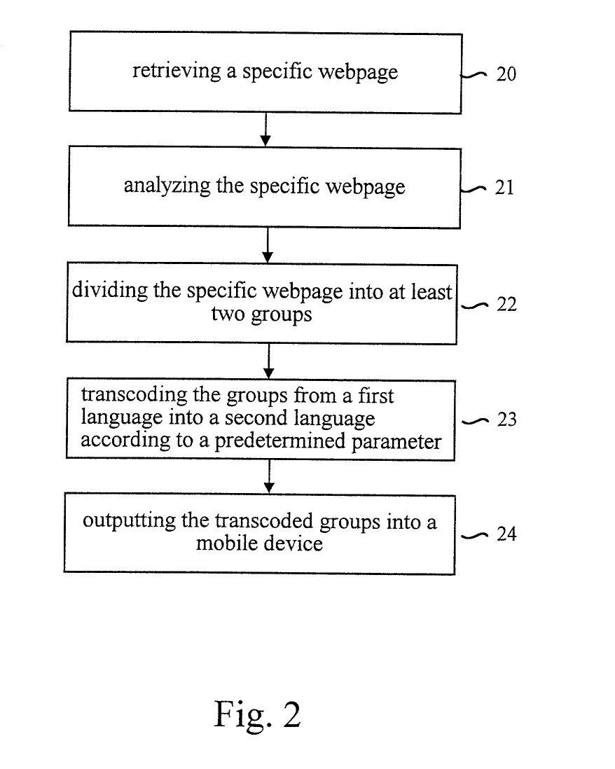

FIG. 2 is a flow chart of the method for transcoding a webpage of the present invention. The detailed processes of the method are described hereinafter.

A user first inputs an URL (comprising a Chinese or English address, a simplified or un-simplified URL address), then the transcode server 13 will fetch a corresponding website homepage source file (such as a HMTL source file) (20). After receiving the HTML source file, the transcode server 13 checks whether a re-direct directive is included in the homepage, and if affirmative, the server 13 re-fetches the specified re-direct homepage. When the final homepage is retrieved, the transcode server 13 will use 1) MSHTML to call for the webpage and analysis the components on the webpage; or 2) use our own DOM parser (iHTMLDOM) to parse the HTML source file (21), if there is no Microsoft platform. Both of the methods will automatically divide the webpage into different groups of objects, hyperlink, text and graphics or a combination (22) thereof. The user or the system can pre-define output parameters. According to different parameters defined by the user, the hyperlink/text/graphics and/or the combination are transcoded from a first language (such as HTML or cHTML) to a second language (such as WML, cHTML PDX or other formats) (23). The transcoding step further comprises the step of transcoding specific icons on iMode and optimizing the icon format such that the non-iMode users can browse the contents of an iMode website. In addition, the present invention is capable of displaying a form on a mobile device for a user to input his personal data, and then the personal data is retrieved by the system for future use. Finally, the transcoded groups are outputted to the mobile devices (such as WAP mobile phones, PDA, Palm, iMode mobile phones or PHS mobile phones) (24).

The transcoded groups are outputted in various predetermined rules. or example, the display order can be based on area of content. According to the present invention, assumed that a particular page of web contents is divided into the following three frames: top, left and right. According to the present invention, the area of each frame is calculated to determine the largest area and show it on the first page. Under normal situation, the largest area is the most important part of the whole webpage. In addition, the transcoded groups can be displayed according to the arrangement of the webpage, such as the top frame on the screen first, then the left hand side frame, the right hand side frame and finally, the bottom frame. Furthermore, the contents of the desired webpage will be automatically separated into several pages for displaying in different mobile devices according to the contents of the webpage and application protocol. Alternatively, the specific contents of webpage (such as flash webpages) will be skipped according to a lookup table.

According to the present invention, the entire spectrum of wireless or wired devices will be supported no matter it is a PDA, Palm, a mobile phone or a PC. During the transcoding process, the specifications of different mobile devices will be detected. For example, the size of the screen, the number of pixel, the number of characters to be displayed in a row, the color of the screen or fonts of the character (traditional Chinese character, simplified Chinese character, Japanese character or Korean character) and so on will be detected and the corresponding formats will be generated to optimize output effect.

After the transcoded groups are outputted to the mobile devices, the target frame will be automatically selected and displayed when there is no response from the user (no input) for a certain period of time. In addition, when the user is browsing the webpages, the user can forward and share the contents (including image) they want directly on their mobile devices, to different devices by SMS/WAP and WAP broadcast and to email addresses.

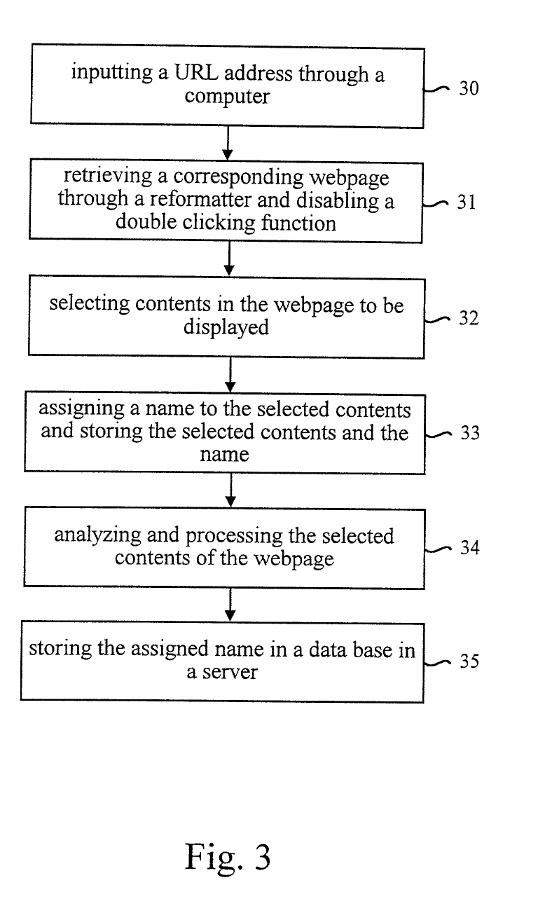

FIG. 3 is a flow chart of the method for creating a personal profile to the accessed webpage contents of the present invention. A user can select the information they want from any websites. The detailed processes of the method are described hereinafter.

A user first inputs a Chinese or English URL address on a personal computer or a mobile device (30). A real-time HTML reformatter will retrieve the corresponding webpage and disable the clicking function (31). The user then selects the contents in the webpage to be displayed on the mobile device (32). The selected contents are assigned a name, and the selected contents and the associated name are stored in a personal profile (33). The main steps of the method for creating a personal profile to the accessed webpage contents of the present invention are now completed. The assigned name can be a simple name to remember such that the input procedure in the future can be simplified. For example, a completed URL address http://www.iscreen.com.tw should be input before; however, in the present invention, it is unnecessary for the user to input the full URL address but just input the main part such as “Iscreen” or even an “i.”According to the present invention, the content of http://www.iscreen.com.tw will be automatically displayed.

The personalized contents of webpage or table will be analyzed by the system of the present invention and processed in the client end (34). Finally, the specific name of the personal profile is stored in the database in the server (35). In addition, the method of the present invention is capable of selecting the contents to be displayed according to predetermined rules, including setting specific hyperlinks, texts, graphics or a combination thereof, thereby displaying or not displaying the specific hyperlinks, texts, graphics or the combination.

Another method for creating a personal profile is primarily designed for Internet content providers. By making use of this methodology, an editor can easily edit the contents to be shown on mobile devices, as the HTML or cHTML can be transcoded into WML, cHTML, PDX or other formats. Editor's configuration will be saved as XML format. The final output can be saved as ASP, WML or cHTML files. All these can be completed at the client end. By periodically refreshing, the automatic update of the contents can be guaranteed. The editor only needs to set up the rules once.

Generally speaking, the contents of webpages comprises ten categories. Each category is processed according to different classifications and predetermined rules. The ten categories comprises 1) simple text information; 2) a page object connected to another page; 3) a page item connected to the WML page; 4) text information of a fixed URL address; 5) hyperlink information of a hyperlink item object; 6) hyperlink information of a webpage for connecting to hyperlink information; 7) hyperlinks to image, video and musical files; 8) input fields of forms; 9) explanation fields of forms; and 10) submit button of form. The contents of webpages are divided into fixed, non-fixed (changeable) hyperlinks or text contents according to the ten categories. The users can utilize graphical interfaces to design an accurate and high quality WML output through such classification. In addition, the users can fine-tune the parameters, such as number of pixel, color shade and color effects, of graphical files to the best effect and then transmit them to different mobile devices.

The second method for creating a personal profile of the present invention comprises the following steps:

1) Input the URL of the webpage that want to be edited

2) selecting a single area, a small area or a large area to be edited depending on necessity;

3) selecting the items on the webpage by a click so as to display an editing window;

4) selecting an object to be edited according to the ten categories of classifications

5) can edit by multiple selections;

6) selecting the attribute of the selected object;

7) setting a relationship between the different objects with different attributes;

8) displaying the edited object;

9) conducting a next level editing for each selected links;

10) establishing a next webpage link to the selected object; and

11) repeating the above steps for editing other objects and items.

The above-mentioned methods can be implemented by computer program instructions. The computer program instructions can be loaded into a computer or other programmable processing devices to perform the functions of the methods illustrated in FIGS. 2 and 3. The computer program instructions can be stored in a computer readable medium. Examples of a computer readable medium include recordable-type medium such as a floppy disc, a hard disc drive, a RAM and CD-ROMs and transmission-type medium such as digital and analog communication links.

According to the methods of the present invention, the webpage contents written by HTML or cHTML are automatically transcoded into WML, cHTML, PDX or other formats such that mobile devices can easily access the Internet. In addition, a document can be analysis according to Document Object Model (DOM) predefined and retrieve the important information on the Internet but not the whole information. Therefore, the present invention can significantly save time and money.

Although the present invention and its advantage have been described in detail, it should be understood that various changes, substitutions and alternations can be made herein without departing from the spirit and scope of the invention as defined by the appended claims.

What is claimed is:

1. A method for transcoding a webpage, comprising the following steps:
(i) retrieving a specific webpage;
(ii) analyzing the specific webpage;
(iii) dividing the specific webpage into at least two groups;
(iv) transcoding the groups from a first language into a second language according to a predetermined parameter; and
(v) outputting the transcoded groups to a mobile device.

2. The method as claimed in claim 1, wherein step (i) further comprises the step of checking whether a re-direct directive is included in the webpage.

3. The method as claimed in claim 1, wherein in step (ii) MSHTML or iHTMLDOM is used to analysis the specific webpage.

4. The method as claimed in claim 1, wherein in step (iii) the at least two groups are hyperlinks, text, graphics or a combination thereof.

5. The method as claimed in claim 1, wherein in step (iv) the predetermined parameter comprises hyperlinks, text, graphics or a combination thereof or specific graphical icons.

6. The method as claimed in claim 1, wherein in step (v) the mobile device is a WAP mobile phone, PDA, Palm, iMode mobile phone or PHS mobile phone.

7. The method as claimed in claim 1, wherein in step (iv) the first language is HTML or cHTML and the second language is cHTML, WML, PDX or other formats.

8. The method as claimed in claim 1, wherein step (v) further comprises the step of displaying the transcoded groups according to predetermined rules, wherein the predetermined rules comprises the rules of re-arranging the groups on the webpage, first displaying the largest group or the top frame on the webpage, dividing the contents of the webpage into several pages for displaying, automatically skipping to next page if no response is received from the user or skipping a specific contents of the webpage.

9. The method as claimed in claim 1, wherein step (i) further comprises the step of inputting a simplified Chinese or English URL.

10. The method as claimed in claim 1, wherein step (v) further comprises the step of detecting specification of the mobile device, wherein the specification comprises the size of the screen, the number of pixel, the number of characters to be displayed in a row, the color of the screen, or fonts of the character including traditional Chinese character, simplified Chinese character, Japanese character or Korean character.

11. The method as claimed in claim 1, further comprising the step of transmitting the contents displayed on the mobile device to other devices.

12. A computer-readable medium encoded with a computer program for transcoding a webpage, the program comprising:
(i) a first instruction for retrieving a specific webpage;
(ii) a second instruction for analyzing the specific webpage;
(iii) a third instruction for dividing the specific webpage into at least two groups;
(iv) a fourth instruction for transcoding the at least two groups from a first language into a second language according to a predetermined parameter; and
(v) a fifth instruction for outputting the transcoded groups to a mobile device.

13. The computer-readable medium as claimed in claim 12, wherein the computer-readable medium is a recordable-type medium of a floppy disc, a hard disc drive, a RAM or CD-ROM, or a transmission-type medium of digital or analog communication link.

14. A method for creating a personal profile, comprising the following steps:
(i) inputting a Chinese or English URL address through a computer or a mobile device;
(ii) retrieving a corresponding webpage through a reformatter and disabling a double clicking function;
(iii) selecting contents in the webpage to be displayed; and
(iv) assigning a name to the selected contents and storing the selected contents and the name.

15. The method as claimed in claim 14, wherein step (iv) further comprises the steps of analyzing the selected contents and further processing the analyzed contents at a client's end.

16. The method as claimed in claim 14, wherein step (v) the assigned name is stored in a database in a server.

17. The method as claimed in claim 14, further comprising the steps of logging in a server and retrieving the personal profile for displaying on a mobile device.

18. The method as claimed in claim 14, further comprising the step of displaying the selected contents according to predetermined rules, wherein the predetermined rules comprises specific hyperlinks, text, graphics or their combinations.

19. The method as claimed in claim 14, further comprising the step of providing a form for inputting personal data.

20. The method as claimed in claim 14, wherein step (iv) the assigned name simplifies the URL address inputted.

21. A computer-readable medium encoded with a computer program for creating a personal profile, the program comprising:
(i) a first instruction for inputting a Chinese or English URL address through a computer or a mobile device;
(ii) a second instruction for retrieving a corresponding webpage through a reformatter and disabling the double clicking function;
(iii) a third instruction for selecting contents in the webpage to be displayed; and
(iv) a fourth instruction for assigning a name to the selected contents and storing the selected contents and the name.

22. The computer-readable medium as claimed in claim 21, wherein the computer-readable medium is a recordable-type medium of a floppy disc, a hard disc drive, a RAM or CD-ROM, or a transmission-type medium of digital or analog communication link.

23. A method for creating a personal profile, comprising the following steps:
(i) selecting at least one item or objects on a webpage;
(ii) selecting at least one object to be edited and selecting a single area, a small area or a large area depending on necessity;
(iii) selecting attributes for the at least one selected object;
(iv) setting relationships between different objects and different attributes; and
(v) conducting a next level editing for each selected items or objects.

24. A computer-readable medium encoded with a computer program for creating a personal profile, the program comprising:
(i) a first instruction for selecting at least one item or objects on a webpage;
(ii) a second instruction for selecting at least one object to be edited and selecting a single area, a small area or a large area depending on necessity;
(iii) a third instruction for selecting attributes for the at least one selected object;
(iv) a fourth instruction for setting relationships between different objects and different attributes; and
(v) a fifth instruction for conducting a next level editing for each selected items or objects.

25. The computer-readable medium as claimed in claim 23, wherein the computer-readable medium is a recordable-type medium of a floppy disc, a hard disc drive, a RAM or CD-ROM, or a transmission-type medium of digital or analog communication link.
